(19) United States
(12) Patent Application Publication
(10) Pub. No.: US 2010/0288169 A1
(43) Pub. Date: Nov. 18, 2010

(54) PALLET

(75) Inventor: Pieter Wouter Du Toit, Paarl (ZA)

Correspondence Address: CONNOLLY BOVE LODGE & HUTZ LLP, 1875 EYE STREET, N.W., SUITE 1100, WASHINGTON, DC, 20006, US

(73) Assignee: Lomold Corporation NV, Curacao (NL)

(21) Appl. No.: 12/668,785

(22) PCT Filed: Jul. 14, 2008
(86) PCT No.: PCT/IB2008/052827

§ 371 Date: Jun. 3, 2010

(30) Foreign Application Priority Data
Jul. 12, 2007 (ZA) 200705727
Jul. 18, 2007 (ZA) 200705907

(51) Int. Cl. B65D 19/38; B29C 45/16

(52) U.S. Cl. 108/57.25; 264/241

(57) ABSTRACT

A pallet (10) of thermoplastic material is provided, as well as a method of making said pallet. The pallet (10) comprises a deck (12), a picture frame (30) spaced below the deck and interconnecting blocks (24,26,28) extending between the deck and the picture frame and the thermoplastic material of which the pallet (10) is made, is reinforced with fibres. The pallet (10) is a unitary moulding and is made by injection moulding in a single step. The method of making the pallet (10) includes compounding the thermoplastic material and fibres and leading the compounded material to an injection unit for injecting it directly into a mould cavity of the injection unit, without a pelletising step.

### FIELD OF THE INVENTION

This invention relates to the manufacture of structural products such as pallets from reinforced recycled polymer. In particular, the invention relates to a pallet of reinforced thermoplastic material and to a method of making a pallet.

### BACKGROUND TO THE INVENTION

Vast numbers of pallets are in use word-wide for the transport and storage of goods. These pallets have historically been made of wood and the majority of pallets presently in use, are still made of wood, but the desirability of wooden pallets is decreasing for a number of reasons. The cost of purchasing wooden pallets has historically been viewed as low, but the cost per cycle of use is high, since the life cycles of these pallets are short and they are often out of service for repairs. When wooden pallets (or parts of wooden pallets) become redundant, they are not recycled, but are simply dumped or burned. In addition to being costly, the use of wooden pallets thus places a high burden on the environment in straining wood sources and in pollution when discarding the pallets.

Pallets made of polymeric materials are available, but have historically been unable to compete with the purchase prices of wooden pallets and have thus not found much favour in commerce. There are multiple reasons for the high cost, but these include: high cost of materials; materials with inadequate strength, requiring the use of excessive masses of material; costly manufacturing techniques; and the like.

Large quantities of polymers are used in the manufacture of consumer goods, that can be recycled, but that are not being recycled. The result is that a heavy burden is placed on the environment in the use of fossil fuels to manufacture the materials, pollution when the products are discarded in landfill sites or are burned, etc. The consumer goods include bottles made of PET and high density polyethylene (HDPE), which are often not recycled because the cost of recycling them in such a manner that they are commercially acceptable to consumers is too high. This often involves substantial amounts of effort in collecting, sorting and washing the bottles for re-use, or collecting, sorting, removal of different types of polymers, removal of printed parts of bottles, etc., for recycling the material of the bottles.

The present invention seeks to address the environmental impact of the use of wooden pallets and the waste of polymeric containers, by the manufacture of pallets from composite materials with optimal mechanical properties, preferably from recycled polymers, in a commercially beneficial manner.

### SUMMARY OF THE INVENTION

According to one aspect of the present invention there is provided a pallet of thermoplastic material comprising a deck, a picture frame spaced below the deck and interconnecting blocks extending between the deck and the picture frame, wherein the thermoplastic material is reinforced with fibres and the pallet is a unitary moulding and is made by injection moulding in a single step. The picture frame can also be referred to as a “bottom deck”.

The deck will be at the top of the pallet in use and is hereinafter referred to as a “top deck”, for the sake of clarity, but the word “top” is not to be given a limiting interpretation in this context. The terms “picture frame” and “interconnecting blocks” are to be accorded their ordinary meanings, as used by persons skilled in the art of plastic pallets, but could be interchanged with the terms “crucifix” and “feet” respectively, also used by persons skilled in the art.

The thermoplastic material may include at least one polyolefin and/or at least one polyester and the polyolefin and/or polyester may be a recycled or reground thermoplastic material. The thermoplastic material may optionally further include an impact modifier and/or a flame retardant.

The pallet may be a heavy duty pallet

The pallet may have a single injection point disposed on the surface of the top deck or the bottom deck and the injection point may be aligned with one of the interconnecting blocks. The injection point may be larger than 10 mm in diameter, preferably larger than 30 mm and more preferably larger than 50 mm in diameter.

The average length of the glass fibres may be at least 10 mm when the thermoplastic material includes a polyolefin.

The glass fibre content of the thermoplastic material may be between 5 and 45%, by weight. In particular, the glass fibre content of the thermoplastic material may be between 30% and 45%, by weight when the base polymer is a polyolefin and the glass fibre content may be between 10% and 30%, by weight when the base polymer is a polyester, e.g. PET.

The term “base polymer” refers to a thermoplastic material which makes up the bulk of the thermoplastic material in the pallet, but which can include other polymers, preferably compatible polymers and/or can have other inclusions or additives, such as additives that compatibilize (also known as plasticisers), chemical bonding additives, UV and impact improving agents, rubbers like EVA EPDM or other nitrile rubbers, pigments, functional polymers or reactive polymers that are commonly referred to as polymers that are enhance by adding Maleac anhydride or other anhydride compositions to the polymer mixture, and/or the like.

The weight of the pallet may be less than 30 kg, even if it is a heavy duty pallet. In particular, the weight of the pallet may be less than 20 kg when the base polymer is a polyolefin and the weight of the pallet may be less than 22 kg when the base polymer is polyester and the polyolefin and/or polyester may include recycled material.

According to another aspect of the present invention, there is provided a method of making a pallet comprising a deck (12), a picture frame (30) spaced below the deck and interconnecting blocks (24,26,28) extending between the deck and the picture frame, said method comprising:

melting a thermoplastic material;
combining the thermoplastic material with reinforcing fibres; and
moulding the pallet by injecting the thermoplastic material into a mould cavity;
wherein the pallet is a unitary moulding and is made by injection moulding in a single step.

The thermoplastic material reinforced with fibres may preferably be injected into the mould cavity through a single injection point and the mould cavity may be closed before the thermoplastic material with reinforcing fibres is injected into said mould cavity.

The method may include compounding the thermoplastic material and fibres and leading the compounded material to an injection unit for injecting it directly into the mould cavity of the injection unit, without a pelletising step. The step of compounding the thermoplastic material and fibres may preferably be continuous and additives may be added to the thermoplastic material in the compounder.

The method may include compatiblising the thermoplastic material by adding a compatibliser, adding impact properties to the pallet by adding additives to the thermoplastic material to improve its impact strength, chemically bonding the thermoplastic material to the fibres, and/or adding a molten polymer such as a drafted polymer or a functional polymer to the thermoplastic material, e.g. through a side arm feed extruder into a twin screw extruder in which the thermoplastic material is melted.

### BRIEF DESCRIPTION OF THE DRAWINGS

For a better understanding of the present invention, and to show how the same may be carried into effect, the invention will now be described by way of non-limiting example, with reference to the accompanying drawings in which:

FIG. 1 is a top three dimensional view of a pallet in accordance with the present invention;

FIG. 2 is a bottom view of the pallet of FIG. 1;

FIG. 3 is a bottom three dimensional view of the pallet of FIG. 1;

FIG. 4 is a diagrammatic representation of the pallet as shown in FIG. 1, but with ribbed surfaces shown as solid surfaces;

FIG. 5 is a diagrammatic top plan view of the pallet of FIG. 1, showing hidden detail;

FIG. 6 is side view of the pallet of FIG. 1;

FIG. 7 is a sectional end view of the pallet of FIG. 1, taken at VII-VII;

FIG. 8 is a detail sectional view of a plugged aperture in the deck of the pallet of FIG. 7;

FIG. 9 is a detail sectional view of a tag cavity of the pallet of FIG. 7; and

FIG. 10 is a detail view of a central interconnecting block of the pallet of FIG. 1.

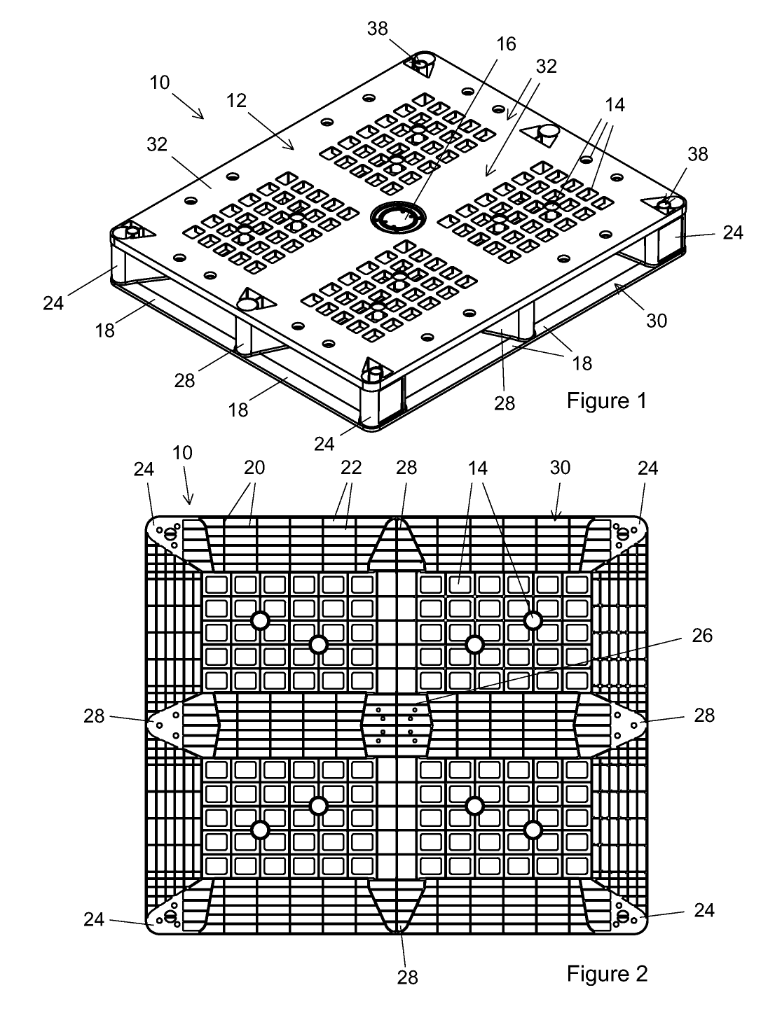

### DETAILED DESCRIPTION OF THE DRAWINGS

One of the main uses of polyester, particularly PET, is in the manufacture of bottles for beverages such as soft drinks, water and beer, sold in large volumes all over the world. For environmental reasons and in order to keep material costs down, it is preferable that the PET from which such bottles are made, is re-used a number of times in order to minimize the use of costly virgin material for everyday production.

Large beverage suppliers currently often wash their post consumer PET bottles seven times before they get granulated into flakes and sold on to the textile industry. However, the beverage suppliers can often only use the unprinted parts of a PET bottle, typically its neck, top and bottom sections, whereas the printed sections have to be cut out before granulation, since the ink blocks equipment used in the textile industry, such as the filters (sand packs) of the spinning pumps used during the manufacturing of yarn or PET fibre.

PET has a number of potential disadvantages that makes buying recycled PET unpopular with converters making structural components. PET is hygroscopic; with the result that the recycled PET flakes need to be dried at the formulation stage before it is fed to a compounder or inside the compounder, to moisture levels below 50 ppm and needs to be dried again before injection moulding the compounded pellet. In order for a converter to process PET successfully in this regard, a thorough knowledge of the materials is required. It is also difficult to compression mould PET as it runs like water having such a low viscosity, making it difficult for a robot to pick up the material and place in into a compression mould, again the converter needs knowledge of viscosity modifiers. PET is also prone to discolouring and can become yellow upon oxidation, especially if it is exposed to atmospheric oxygen in its molten state.

In order to obtain a cost effective source of thermoplastic material for manufacturing pallets, it is proposed in the present invention to implement a system whereby the beverage industry can recover large numbers of PET beverage bottles, crates, syrup bottles, etc. by using a deposit system. This will also reduce the quantities of these objects that are discarded in practices that are harmful to the environment. Beverage providers can presently only use a maximum of 30% recycled PET when manufacturing beverage bottles, the balance being make up of virgin PET. The balance of recycled PET thus presently goes to waste.

Instead of the wastages of PET bottles being an embarrassment for the beverage industry, it can be provided to manufacturers of pallets, to manufacture pallets for use by the beverage industry from the material of these recycled PET articles and the provision of pallets to the industry can be used to compensate the industry for providing the PET raw material. However, the production of a pallet from PET, especially from recycled PET poses a number of challenges, including the difficulties of using the PET material as described above, as well as challenges in manufacturing pallets cost effectively with sufficient strength.

According to some embodiments of the present invention, the PET articles that are obtained from the beverage industry, as set out above, are taken in their whole condition, including bottle caps, ink directly printed on the bottle and/or paper labels, tamper-evident skirts, and the like and are granulated and mixed, without sorting, filtering, washing, or the like. The granules are fed, preferably with polyolefins into a continuous compounder, preferably a twin screw compounder and are combined with additives such as impact modifiers, compatibilisers, flame retardants, etc. while being compounded.

In this example, the use of polymers in the form of a combination of PET and polyolefins is described. However, in other embodiments of the invention other polyesters can be combined with polyolefins or instead of using a blend of polyesters and polyolefins, the polyesters can be omitted. The material used in each case can be virgin material or can be recycled material and the advantages described herein in relation to PET bottles, applies equally to other products made from polyesters and/or polyolefins. Also, while it is generally advantageous to use blends of polyolefins and/or blends of polyesters, it is possible to use a single polyolefin or a single polyester. For the sake of brevity and clarity, reference is only made to PET in the example described below, but this is merely a non-limiting example, which applies equally to any suitable combination of polyester(s) and/or polyolefin(s).

The use of PET according to the present invention in the manufacture of structural components in the form of pallets with dimensions that are much larger than the diameters of textile yarns and the like, means that there is no need for the PET to be filtered and consequently no need for the ink printed parts of PET bottles to be separated or discarded. Accordingly, whole PET bottles can be used as a source of material for pallet manufacture and the PET bottles can be granulated or flaked, can be fed directly into the compounder and from there directly into a thermoplastic product, without the need to go through any screen changer/filter.

Glass fibres (or other suitable fibres) are fed to the compounder, preferably downstream of the screws to limit fibre breakage in the high shear environment of the screws. The molten PET and fibres thus form a composite material in which the PET is the matrix. The glass is preferably bonded to the PET matrix by mechanical bonding, but the bond is enhanced by the working of coupling agents applied or grafted to the fibres, which cause the matrix to bond chemically to the fibres. The glass fibres are fed into the compounder as continuous rovings or as chopped strands and can have various or the same lengths.

Preferably, the average length of the glass fibres is substantially longer than 10 mm and the glass fibre content of the composition is between 15% and 30%. This percentage could be increased to 30% to 45% if the polymer matrix is comprised primarily of a polyolefin, such as HDPE.

The disadvantages of PET are largely overcome in the method of the present invention by feeding the composite material prepared in the compounder directly to a mould for making a pallet by injection moulding. This does not mean that there are no holding or metering cavities or accumulators, but by “directly” is meant without any intermediate process steps that are not related to the feeding of the composition to the mould, i.e. the polymer is kept in the molten state and is not pelletised. This direct process is also referred to herein as “moulding in a single step” and has a number of advantages including the prevention of polymer degradation, moisture accumulation, savings in energy requirements (since the material does not have to be melted again), retention of fibre length, etc.

The mould is already closed when the composition is fed into the mould cavity via a single injection point with a large diameter, preferably of the order of 50 mm to 100 mm in diameter. The injection point is preferably at a central point on a deck of the pallet and is aligned with a central interconnecting block of the pallet. This assists in rapid distribution of the molten composition in the mould even at low injection pressures. Further, the use of a single injection point prevents the formation of weld lines, which are usually formed in traditionally injection moulded plastic pallets where material fed into a mould from multiple injection points, meet.

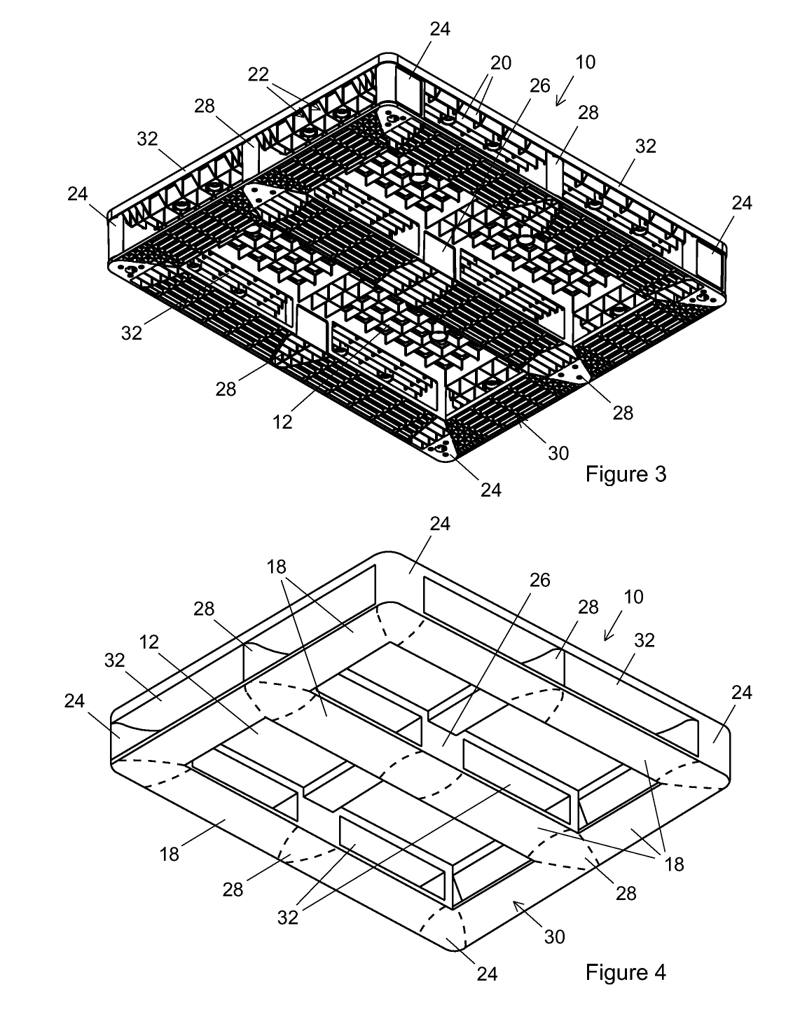

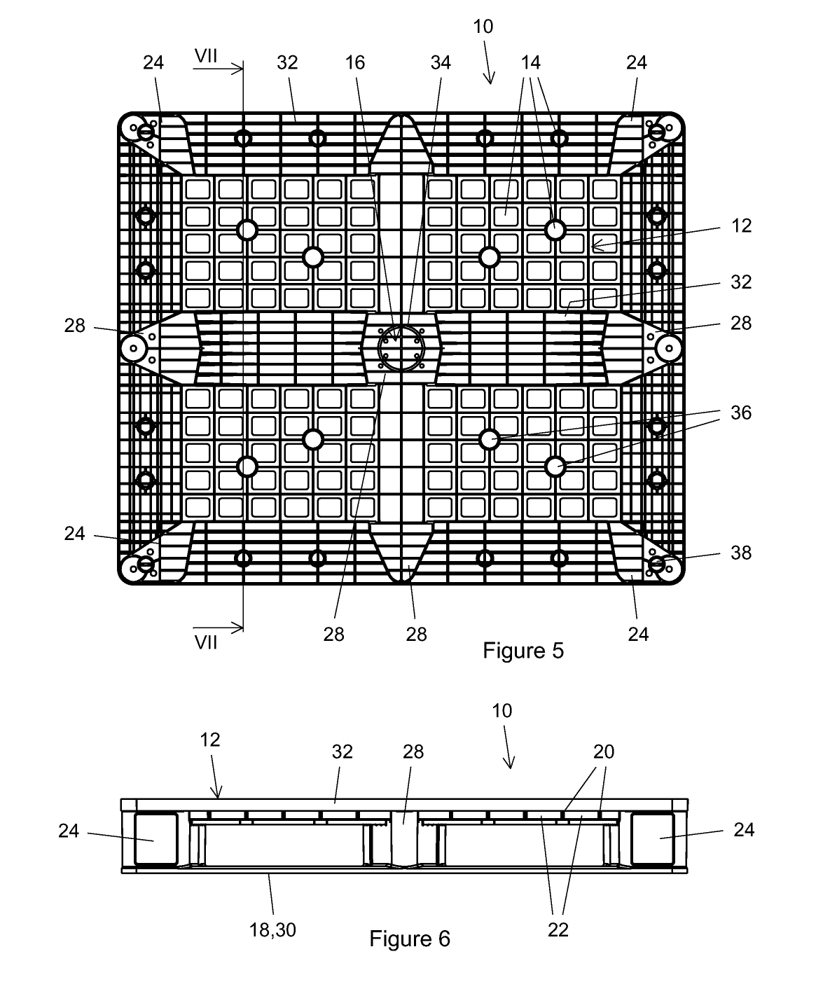

An example of a pallet in accordance with the present invention that is manufactured in the described process, is illustrated in the drawings and is generally indicated by reference numeral 10. The pallet 10 is a unitary moulding that is injection moulded from the composite material described above and comprises of a large number of interconnected thin walls or ribs 20 defining apertures or recesses 22 between them, rather than a solid construction. This assists in keeping the weight of the pallet 10 to a minimum and thus to save in material costs and to make the pallet more economical to operate, while retaining its strength. However, for the sake of illustration of the features described below, the pallet 10 as shown in FIG. 3 is shown as a solid pallet in FIG. 4, as it would hypothetically appear if the recesses 22 between ribs 20 were filled. The spacing between each of the ribs 20 is less than 27 mm, with the result that the pallet 10 acts very similarly in many respects, as it would have if it had been solid as shown in FIG. 4—e.g. the narrow spacing between adjacent ribs 20 ensures that pressure is distributed along the underside of the pallet 10 when it rests on a supporting surface, which is discussed in more depth below.

The pallet 10 has a generally planar upper deck 12 with a number of apertures 14 for weight reduction and the pallet extends continuously downwardly from the deck at nine locations via interconnecting blocks or feet. The interconnecting blocks include four corner blocks 24, a central block 26 and four mid-side blocks 28, midway between each pair of corners. At the lower ends of the connecting blocks, the pallet includes a cruciform or picture frame 30 comprising of beams 18 that extend between adjacent interconnecting blocks along the periphery of the pallet's underside and across its underside, between two opposing mid-side blocks 28 and the central block 26.

The cross-sectional profile of each beam 18 extending around the lower periphery of the pallet 10 is tapered, to have a thickness at its outside edge (i.e. at the periphery) of about 9 to 12 mm and a thickness at its inside edge of about 12 to 20 mm. The asymmetrical or tapered profile of the beams 18 has the result that it is much thinner at the entry point where the forks of a fork lift enters the pallet, while being thicker at the exit where the forks leave the picture frame 30. The thin profile of the beams 18 at the entry point allow the forks to enter the pallet with ease, while the thick exit from the picture frame 30 (i.e. at the inside edge of the picture frame) provides tactile feedback to a fork lift operator that he can feel on the controls of the fork lift when the ends of the fork pass the exit of the picture frame.

Each of the beams 18 has a width that exceeds 100 mm and similarly, parts of the deck 12 that extend between the areas of apertures 14 (i.e. the parts that appear solid from above) form beams 32 in the deck that also have widths that exceed 100 mm. The width of the beams 18,32 provide structural strength and load distribution to the pallet 10, which is enhanced by the ribs 20 on the underside of each beam. The ribs 20 in the upper beams 32 are chamfered around the periphery of the pallet 10 and this chamfer performs the same function as the tapered profile of the lower beams 18 as described above.

The combined bottom area of the picture frame 30, i.e. including the undersides of the lower beams 18 and the interconnecting blocks 24,26,28 comprises more than 55% of the area of the pallet 10. This, together with the functioning of the narrow spacing of the ribs 20, allows for a very wide area of load distribution if the pallet (and any load it may carry) is supported on a surface below. The larger area means that loading pressures are kept low and this is particularly important when loaded pallets are stacked on top of one another and the loaded goods on a lower pallet has to bear the weight of an upper pallet and its load, via the interface of the upper pallet's picture frame on the lower pallet's load.

Reference has been made above to the fact that the pallet 10 is made by injecting the polymer and fibre material into the mould cavity via a single, large injection point. The injection point 16 of the pallet 10 is in the middle of the deck 12 and is aligned with the central interconnecting block 26, to assist in rapid distribution of the molten composition in the mould. The distribution of the molten composition is further enhanced by a cylindrical passage in the mould cavity, inside the central interconnecting block 26, as well as the ribs 20 throughout the pallet 10.

The central interconnecting block 26 is tapered on all sides and material that solidifies in the cylindrical passage inside the interconnecting block, form a pipe structure 34, which together with the ribs 20 give the block substantial structural strength. The result of the tapered shape of the central interconnecting block 26 is that prongs of a fork lift that inadvertently hit the block are deflected and the structural strength of the block ensures that it is resilient enough not to be damaged easily by the fork prongs and recoils after impact.

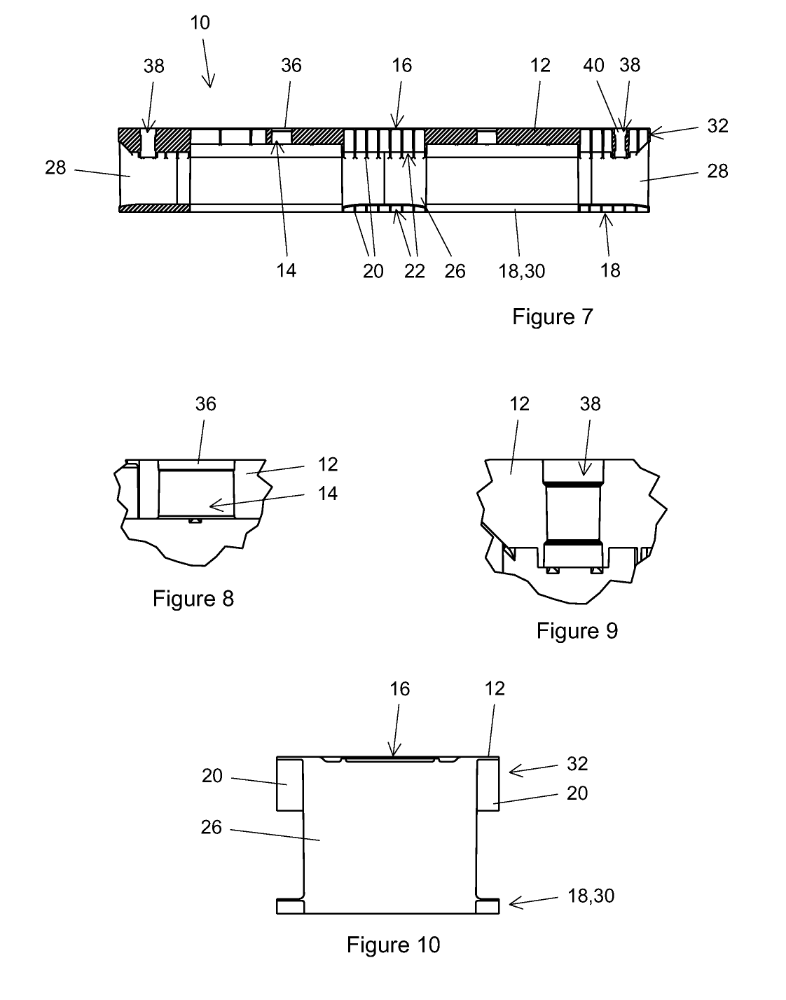

As is best illustrated in FIG. 7, some of the apertures in the deck 12 are round and are can receive plugs 36 of different materials that are preferably generally flush with the deck, e.g. non-slip materials to prevent loads from slipping on the deck or materials of distinctive colours that can assist in identifying different pallets.

The pallet 10 defines four cylindrical cavities 38, one in each of the four corner interconnecting blocks 24 and each cavity has an opening in the deck 12 that can be plugged, preferably in a watertight manner. The cavities 38 are intended to carry identification tags such as RFID tags that can be used to identify the pallets, but are suited to carry any other identifying equipment, e.g. identification or tracking technologies that may still be developed. In a presently preferred embodiment, special plugs 40 are used that extend into the cavities 38 and that are configured to seal the cavities watertight with the aid of O-rings and to carry the RFID tags. The preferred configuration of the cavities 38 in which the RFID tags are carried without permanent fixture to the pallet 10 allows them to be replaced or supplemented in future with other tracking/identifying equipment. Further, the installation of the RFID tags in the corner interconnecting blocks 26 ensures that they are surrounded by a strong structure, from where they are not easily removed if the pallet is damaged, e.g. during rough handling of the pallet 10.

The pallet 10 can be a light, medium or heavy duty pallet and has a weight of less than 30 kg. In fact the weight of the pallet 10 is less than 25 kg and in embodiments where the polymer comprises mostly of polyolefin, the weight of the pallet can be less than 20 kg. The low mass of the pallet 10 has advantages of low material cost, but in addition, it allows more than one of the pallets to be injection moulded from one extruder, thus increasing production efficiency.

Further, the pallet 10 has a height that is less than that of any other pallet presently on the market by about 20%, despite the fact that the pallet 10 has the same structural strength as that of the higher conventional pallets.

The thermoplastic material of the pallet 10 has a flexural modulus in excess of 5000 MPa, a tensile strength at yield of at least 60 MPa and a notched Izod impact strength at room temperature in excess of 200 J/m.

The cost of the pallet 10 can compete favourably with the cost of wooden pallets, especially if it is borne in mind that the life cycle of the pallet 10 is expected to be markedly longer than that of wooden pallets and the pallet 10 will not need any maintenance, as it will simply be used until it is no longer serviceable, at which time it will be granulated in the same way as the PET bottles, for use in the manufacture of new pallets 10.

1. A pallet of thermoplastic material comprising a deck, a picture frame spaced below the deck and interconnecting blocks extending between the deck and the picture frame characterised in that said thermoplastic material is reinforced with fibres, said pallet is a unitary moulding and is made by injection moulding in a single step.

2. A pallet as claimed in claim 1, characterised in that said thermoplastic material includes at least one polyolefin.

3. A pallet as claimed in claim 1, characterised in that said thermoplastic material includes at least one polyester.

4. A pallet as claimed in claim 1, characterised in that said thermoplastic material includes recycled thermoplastic material.

5. A pallet as claimed in claim 1, characterised in that the pallet has a single injection point.

6. A pallet as claimed in claim 5, characterised in that said injection point is disposed on the surface of the deck.

7. A pallet as claimed in claim 5, characterised in that said injection point is disposed on the picture frame.

8. A pallet as claimed in claim 5, characterised in that said injection point is aligned with one of the interconnecting blocks.

9. A pallet as claimed in claim 5, characterised in that said injection point is larger than 10 mm in diameter.

10. A pallet as claimed in claim 9, characterised in that said injection point is larger than 30 mm in diameter.

11. A pallet as claimed in claim 10, characterised in that said injection point is larger than 50 mm in diameter.

12. A pallet as claimed in claim 1, characterised in that the average length of the fibres is more than 10 mm when the thermoplastic material includes a polyolefin.

13. A pallet as claimed in claim 1, characterised in that the fibre content of the thermoplastic material is between 5% and 45%, by weight.

14. A pallet as claimed in claim 13, characterised in that the thermoplastic material comprises substantially of at least one polyolefin and the fibre content of the thermoplastic material is between 20% and 45%, by weight.

15. A pallet as claimed in claim 13, characterised in that the thermoplastic material includes a substantial quantity of at least one polyester and the fibre content is between 5% and 30%, by weight.

16. A pallet as claimed in claim 1, characterised in that the weight of the pallet is less than 30 kg.

17. A pallet as claimed in claim 16, characterised in that the thermoplastic material comprises substantially of at least one polyolefin and the weight of the pallet is less than 20 kg.

18. A pallet as claimed in claim 17, characterised in that the thermoplastic material includes recycled polyolefin.

19. A pallet as claimed in claim 16, characterised in that the thermoplastic material includes a substantial quantity of at least one polyester and the weight of the pallet is less than 22 kg.

20. A pallet as claimed in claim 19, characterised in that the thermoplastic material includes recycled polyester.

21. A method of making a pallet comprising a deck, a picture frame spaced below the deck and interconnecting blocks extending between the deck and the picture frame, said method comprising:
melting a thermoplastic material; combining said thermoplastic material with reinforcing fibres;
and moulding said pallet by injecting said thermoplastic material into a mould cavity;
characterised in that said pallet is a unitary moulding and is made by injection moulding in a single step.

22. A method as claimed in claim 21, characterised in that said thermoplastic material reinforced with reinforcing fibres is injected into said mould cavity through a single injection point.

23. A method as claimed in claim 21, characterised in that said mould cavity is closed before the thermoplastic material with reinforcing fibres is injected into said mould cavity.

24. A method as claimed in claim 21, characterised by compounding the thermoplastic material and fibres and leading said compounded material to an injection unit for injecting it directly into said mould cavity of the injection unit, without a pelletising step.

25. A method as claimed in claim 24, characterised in that the step of compounding the thermoplastic material and fibres is continuous.

26. A method as claimed in claim 21, characterised by adding a compatibiliser to the thermoplastic material.

27. A method as claimed in claim 21, characterised by adding additives to the thermoplastic material to improve its impact strength.

28. A method as claimed in claim 21, characterised by chemically bonding the thermoplastic material to the fibres.

29. A method as claimed in claim 21, characterised by adding a molten polymer to the thermoplastic material.

30. A pallet of thermoplastic material comprising a deck, a picture frame spaced below the deck and interconnecting blocks extending between the deck and the picture frame characterised in that said thermoplastic material is reinforced with fibres, said pallet is a unitary moulding and is made by injection moulding in a single step characterised in that said pallet is made by a method as claimed in claim 21.
